(19) United States
(12) Patent Application Publication
(10) Pub. No.: US 2023/0110344 A1
(43) Pub. Date: Apr. 13, 2023

(54) THREE-DIMENSIONAL IMAGES CREATIONS

(71) Applicant: Hewlett-Packard Development Company, L.P., Spring, TX (US)

(72) Inventors: Christopher Steven, Spring, TX (US); Richard E. Hodges, Spring, TX (US)

(21) Appl. No.: 17/498,995

(22) Filed: Oct. 12, 2021

(51) Int. Cl. H04N 13/236; H04N 13/296; H04N 5/232; H04N 13/156

(52) U.S. Cl. CPC H04N 13/236; H04N 13/296; H04N 5/23238; H04N 13/156

(57) ABSTRACT

Examples described herein relate to an imaging device. For instance, the imaging device can comprise a plurality of lenses to receive light, a reflector to transmit the light from the plurality of lenses through a shaft, a mirror to receive the light transmitted by the reflector and reflect the light into a sensor, a motor to rotate the mirror to allow the mirror to channel light into the sensor, the sensor to a set of frames of image data based on the light received from the mirror, and a processing resource to synchronize a motor speed based on the set of frames.

### BACKGROUND

Devices, including cameras, are used to record images. The devices receive light through light sources to generate images. In some examples, the device includes imaging sensors to capture images to be displayed on a display device. In some examples, the imaging sensors are capable of capturing still images and/or video images.

### BRIEF DESCRIPTION OF THE DRAWINGS

FIG. 1 illustrates an example of an imaging device including a sensor consistent with the disclosure.

FIG. 2 illustrates an example apparatus including a processing resource and a memory resource suitable with an imaging device including a sensor consistent with the disclosure.

FIG. 3 illustrates an example of a flow diagram suitable with an imaging device including a sensor consistent with the disclosure.

FIG. 4 illustrates an example diagram of a non-transitory machine-readable medium suitable with an imaging device including a sensor consistent with the disclosure.

FIG. 5 illustrates an example of an imaging device including a sensor consistent with the disclosure.

### DETAILED DESCRIPTION

An imaging device includes sensors to produce image data. The image data from the imaging device can be used to create 3-dimensional (3D) images. The sensor can be used to capture the angles of the recording area to create the 3D image. However, using multiple sensors can increase the size and the cost of production of the imaging device. Some imaging devices use low quality sensors to reduce the cost of the imaging device. However, using low quality sensor reduces the quality of the 3D image, as compared to using higher quality sensors. In some examples, a high-quality sensor captures image data above a threshold resolution and a low-quality sensor captures image data below the threshold resolution. In addition, some imaging devices use the processing resource on the imaging device to create the 3D imaged before the image is sent to an external computing device. However, processing the 3D image on the device can increase the size of imaging device by adding additional components used to process the data.

Accordingly, this disclosure describes an imaging device that includes a single sensor to produce frames of image data and uses a motor rotating a mirror to capture multiple different angles of the recording area. Using a single sensor to produce the frames reduces the size and cost of the device, as compared to imaging devices that used multiple sensors. Further, as described herein, using a motor to rotate a mirror allows the one sensor to receive data from multiple different angles of the viewing area. In addition, the imaging device described herein does not have to compromise the quality of the sensor to reduce the cost of producing the imaging device since the imaging device uses one sensor and not multiple sensors.

As such, the imaging device described herein uses one sensor to produce image data within a compact imaging device with a reduce production cost and size, as compared to imaging devices with multiple sensors. For example, the imaging device includes a plurality of openings on an enclosure to receive light. The enclosure includes a reflector disposed within the enclosure to transmit the light received from the opening through a shaft to a mirror. A motor is used to rotate the mirror as light is being transmitted to the mirror or received by the mirror and reflected to a sensor. The sensor is used to produce frames of image data based on the light received from the rotating mirror. The imaging device further includes a processing resource to synchronize an image based on the speed of the motor and the number of frames of image data produced by the sensor.

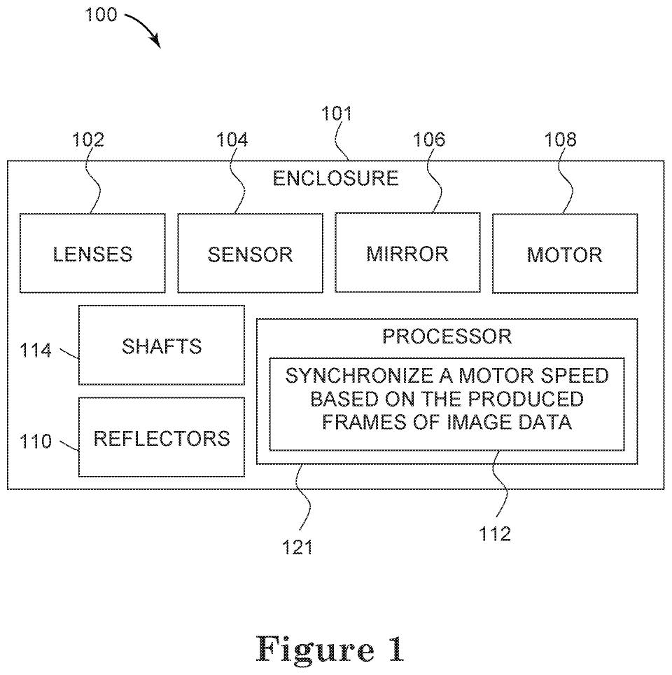

FIG. 1 illustrates an example of an imaging device 100 including a sensor 104 consistent with the disclosure. The imaging device 100 includes an enclosure 101 which includes elements such as a sensor 104, mirror 106, reflectors 110, and a motor 108 to produce frames of image data. For example, the imaging device 100 includes a plurality of lenses 102 to receive light. That is, the plurality of lenses 102 bring light into the enclosure 101. The plurality of lenses 102 are positioned around the enclosure 101, such that, each lens of the plurality of lenses 102 has a different position on the outer surface of the enclosure 101. In some examples, each lens of the plurality of lenses 102 is parallel and/or adjacent to another lens of the plurality of lenses 102.

In some examples, the plurality of lenses 102 captures light and send the light to other elements within the enclosure 101. For instance, the plurality of lenses 102 capture the light entering in the enclosure 101 and send the light to a plurality of corresponding reflectors 110. In some examples, the imaging device 100 includes a plurality of reflectors 110 within the enclosure 101. For example, the imaging device 100 includes four (4) reflectors positioned at a ninety (90) degree angles to form a square or rectangular shape. The reflectors transmit light from the plurality of lenses 102 to a mirror 106 of the imaging device 100. As used herein, “reflector” refers to an object or device that shines light in a set direction. As used herein, “mirror” refers to a surface that forms images by reflection.

In some examples, the imaging device 100 includes a mirror 106 positioned substantially in the center of the enclosure 101. As used herein, the term substantially intends that the characteristic does not have to be absolute but is close enough so as to achieve the characteristic. For example, “substantially centered” is not limited to absolute centered. For example, “substantially the same” is not limited to absolutely the same. The reflectors 110 transmit the light received from the plurality of lenses 102 to the mirror 106 positioned substantially in the center of the enclosure 101. For instance, the plurality of reflectors 110 redirect the light from the plurality of lenses 102 and transmit the light through shafts 114. The shafts 114 create a path from the plurality of reflectors to a mirror 106. That is, the plurality of reflectors 110 transmit the light received from the plurality of lenses 102 to a mirror 106 via the plurality of shafts 114. As used herein, “shaft” refers to an enclosed opening that forms a passageway.

In some examples, the mirror 106 rotates as light is being received from the plurality of reflectors 110. For instance, a motor 108 turns the mirror 106 as light is being received by the mirror 106. In addition, the mirror 106 transmits the light received from the plurality of reflectors to a sensor 104 as the mirror 106 rotates. That is, as the mirror 106 rotates, the light received from the plurality of reflectors 110 is received by the sensor 104. The sensor 104 uses the light from the mirror 106 to produce frames of image data. In some examples, the sensor 104 is positioned substantially in the center of the enclosure 101. That is, the sensor 104 can be parallel with the mirror 106. For instance, the sensor 104 can be positioned on a second side of the mirror 106, while the motor 108 can be positioned on the first side of the mirror 106. As used herein, “motor” refers to an electrical machine that converts electrical energy into mechanical energy.

In some examples, the speed of the motor 108 is used to determine the number of frames of image data produced in a revolution of the mirror 106. For example, the motor 108 can run at 14,400 revolutions per minute which causes a mirror 106 to rotate at 240 revolutions per second. In some examples, the motor 108 can run at 43,200 revolutions per minute which causes a mirror 106 to rotate at 720 revolutions per second. That is, the motor 108 can run from up to 14,400 to 43,200 revolutions per second to cause the mirror 106 to rotate from up to 240 to 720 revolutions per second. The mirror 106 transmits light to the sensor 104 to cause the sensor 104 to produce frames of image data. In some examples, the sensor 104 can produce 8 frames of image data per second, when the mirror rotates at 240 revolutions per second. In some examples, the sensor 104 can produce 24 frames of image data per second when the mirror rotates at 720 revolutions per second. That is, the sensor 104 produces from up to 8 to 24 frames of image data per second when the mirror 106 rotates from up to 240 to 720 revolutions per second.

In some examples, the imaging device 100 includes a processing resource 121 to cause the motor 108 to synchronize with the sensor 104. That is, the motor 108 is set to a particular speed level to allow the sensor 104 to produce a set number of frames of image data per revolution. That is, the imaging device 100 uses light received from a plurality of lenses 102 to produce multiple frames of image data from one sensor 104. The motor 108 is able to cause a mirror 106 to rotate and receive light from the plurality of reflectors 110. The mirror 106 then sends the light to the sensor 104 and the sensor 104 is able used the light to produce frames of image data. In some examples, the amount of light the mirror 106 receives is based on the speed the mirror 106 rotates. Said differently, the amount of light the mirror 106 receives is based on the speed at which the motor 108 rotates the mirror 106.

In some examples, the sensor 104 is a removable sensor 104. That is, the sensor 104 can be removed and replaced with another sensor. In some examples, the sensor 104 is selected to produce frames of images from a variety of quality ranges. For example, the sensor 104 can produce frames of image data that are 4K quality or below, frames of image data that are 8K quality or better, or other quality ranges. Hence, the quality of the images produced by the sensor 104 depends on the quality of the sensor 104 installed in the enclosure 101 of the imaging device 100.

In some examples, the imaging device 100 including one sensor can be smaller than other imaging devices that include multiple sensors. Further, using one sensor 104 to create frames of image data can reduce the cost of the imaging device 100, compared to imaging devices that use multiple sensors. Further, the imaging device 100 can be upgraded as technology changes by replacing the one sensor 104 included in the enclosure 101. That is, the imaging device 100 including the sensor 104 can be a produced with a lower cost and can be smaller in size compared to imaging sensors with multiple sensors.

In some examples, the imaging device 100 includes a plurality of lenses 102 to receive light through openings of an enclosure 101. The openings of the imaging device 100 are positioned at different angles on the imaging device 100. The imaging device 100 includes a reflector 110 to transmit the light from the plurality of lenses 102 through a shaft 114. In some examples, the imaging device 100 includes a plurality of reflectors 110 and a plurality of shafts 114 to transmit light from the plurality of lenses 102. That is, the imaging device 100 includes a shaft 114 for each reflector 110. In some examples, the imaging device 100 includes a mirror 106 to receive the light transmitted by the reflector 110 and reflect the light at a sensor 104.

A motor 108 is used to rotate the mirror 106 to allow the mirror 106 to direct light at the sensor 104. In some examples, the sensor 104 produces frames of image data based on the light received from the mirror 106. That is, as the mirror 106 rotates the mirror 106 directs light to the sensor 104 to produce frames of image data. In some examples, the frames of image data produced in a revolution produces image data from a plurality of different angles. A processing resource 121 synchronizes the motor speed based on the number of frames of image data produced by the sensor 104. In some examples, the quantity of frames of image data produced in a revolution is based on a speed of the motor 108.

In some examples, the processing resource 121 detects when light is received through a plurality of lenses 102 positioned on a surface of an enclosure 101. In addition, the processing resource 121 detects when a reflector 110 transmits the light through a shaft 114 to contact a mirror 106. The mirror 106 is located substantially in a center of the enclosure 101.

In some examples, the processing resource 121 instructs a motor 108 to rotate the mirror 106 to reflect the light from the plurality of lenses 102 into a sensor 104. The motor speed can be determined by the processing resource 121 to produce a set number of frames per revolution. In some examples, the sensor 104 produces frames of images from the light reflected into the sensor 104.

In some examples, the processing resource 121 determines when the set of frames in a revolution match. That is, the processing resource 121 determines when the set of frames produced in a revolution are substantially the same and/or substantially match. For example, the processing resource 121 determines when a substantially same image is produced in consecutive frames captured by the sensor 104. If it is determined that the image is substantially the same in consecutive frames of image data, the processing resource 121 adjusts a motor speed in response to the determination. If it is determined that the image is substantially the same in consecutive frames of image data, the processing resource 121 refrains from adjusting a motor speed. As used herein, “same” refers to being similar, identical, and/or not different. As used herein, “match” refers to being equal to another thing in characteristics and appearance.$

In some examples, every other frame of image data of the produced frames of image data are stitched together to make two panorama images. In some examples, the processing resource 121 sends the produced frames of image data to an external computing device. For example, the processing resource 121 sends the two panorama images to an external computing device. In some examples, the two panorama images are used to create a three-dimensional (3D) image. As used herein, external “computing device” refers to electronic equipment controlled by a CPU, and/or a system that provides resources, data, services, etc. to other computers. For example, an external computing device can be a desktop computer, a laptop computer, a tablet, a phone, a phablet, server, etc. not connected to the imaging device.

In some examples, the imaging device 100 includes an enclosure 101 that includes a plurality of openings positioned on a surface of the enclosure 101 to receive light. The enclosure 101 further includes a shaft to connect a reflector 110 to a mirror 106. The reflector 110 receives the light from each opening of the plurality of openings and transmits the light through the shaft 114 to the mirror 106. The mirror 106 reflects the light into a sensor 104. In some examples, the processing resource 121 instructs a motor 108 to rotate the mirror 106 to reflect the light received from the plurality of openings into the sensor 104. The processing resource 121 further instructs the sensor 104 to capture frames of images based on the light received from the plurality of openings. In some examples, each opening of the plurality of openings is covered by a unique lens of the plurality of lenses 102. That is, there is a lens within the plurality of lens paired to each opening. However, this disclosure is not so limited. As described herein, the imaging device can include one lens to cover each opening as light is received by the opening.

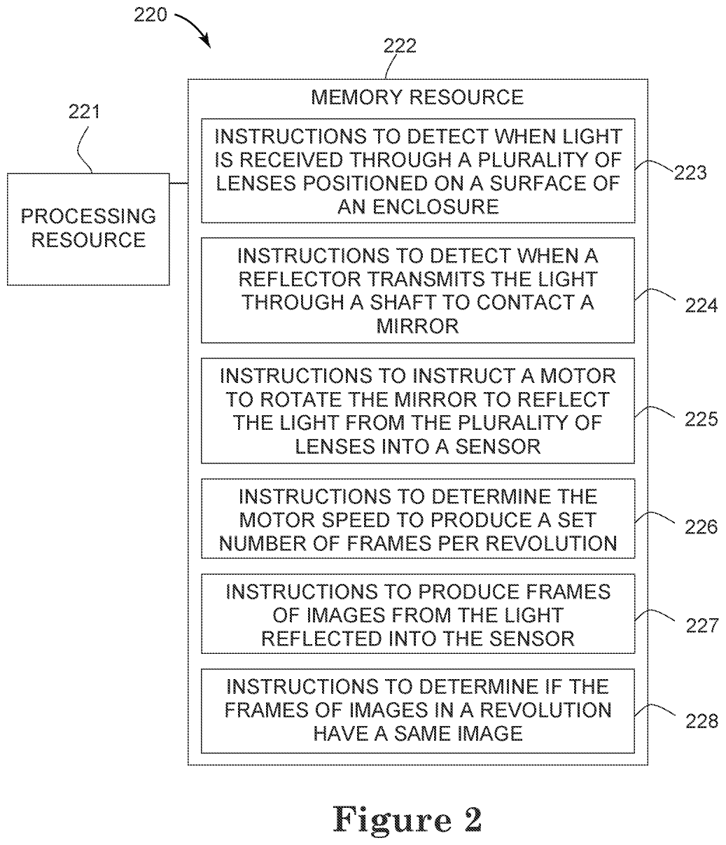

FIG. 2 illustrates an example apparatus 220 including a processing resource 221 and a memory resource 222 suitable with an imaging device including a sensor consistent with the disclosure. As illustrated in FIG. 2, the apparatus 220 includes a processing resource 221 and a memory resource 222. The processing resource 221 is a hardware processing device such as a microprocessor, application specific instruction set processor, coprocessor, network processor, or similar hardware circuitry that causes machine-readable instructions to be executed. In some examples, the processing resource 221 may be a plurality of hardware processing devices that may cause machine-readable instructions to be executed. The processing resource 221 may include central processing units (CPUs) among other types of processing devices. The processing resource 221 may also include dedicated circuits and/or state machines, such as in an Application Specific Integrated Circuit (ASIC), Field Programmable Gate Array (FPGA) or similar design-specific hardware. The memory resource 222 may be any type of volatile or non-volatile non-transitory memory, such as random-access memory (RAM), flash memory, read-only memory (ROM), storage volumes, a hard disk, or a combination thereof.

The memory resource 222 may store instructions thereon, such as instructions 223, 224, 225, 226, 227, and 228. When executed by the processing resource 221, the instructions may cause the apparatus 220 to perform specific tasks and/or functions. For example, the memory resource 222 can store instructions 223, that when executed by the processing resource 221, cause the processing resource 221 to detect when light is received through a plurality of lenses positioned on a surface of an enclosure. In some examples, the imaging device includes a plurality of lenses positioned on the surface of an enclosure. The imaging device uses the lenses to capture light to produce frames of image data. In some examples, the processing resource 221 detects when the imaging device is activated and when light is being received through the plurality of lenses. The processing resource 221 can monitor the amount of light being received through the plurality of lenses to determine the number of frames of image data that will be produced in each revolution of a mirror within the enclosure. That is, the imaging device includes a mirror to receive the light received by the plurality of lenses when the imaging device is activated.

The memory resource 222 can store instructions 224, that when executed by the processing resource 221, cause the processing resource 221 to detect when a reflector transmits the light through a shaft to contact a mirror. In some examples, the imaging device includes a plurality of reflectors to transmit light received by the plurality of lenses to a mirror. For instance, each reflector receives light from a lens of the plurality of lenses. Each reflector of the plurality of reflectors then directs or sends the light received from the respective lens through a shaft connected to the reflector. The shaft leads to a mirror positioned substantially in the center of the enclosure. In some examples, the processing resource 221 detects when the plurality of reflectors transmits the light through the shaft to the mirror positioned substantially in the center of the enclosure. In some examples, the processing resource 221 determines the speed (e.g., rotational speed, etc.) of the mirror as the mirror receives light from the reflector. That is, the processing resource 221 determines the amount of light the mirror sends to the sensor to determine the number of frames of image data the sensor can produce in a revolution of the mirror.

The memory resource 222 can store instructions 225, that when executed by the processing resource 221, cause the processing resource 221 to instruct a motor to rotate the mirror to reflect the light from the plurality of lenses into a sensor. In some examples, the mirror rotates as light is sent from the mirror into the sensor. That is, the processing resource 221 instructs the motor to rotate the mirror when the imaging device is activated and when light is received by the plurality of lenses. The mirror can rotate at varying speeds based on the determined quantity of frames of image data that is to be produced by the sensor. For instance, the faster the mirror rotates, the faster the mirror can send the light to the sensor. The speed at which the sensor receives different portions of light can help determine the number of frames of image data produced by the sensor. That is, the faster the mirror rotates, the faster the sensor receives different angles of the light allowing the sensor to produce more frames of image data per second as compared to a slower speed of the rotating mirror. Using a motor to rotate a mirror to introduce light into the sensor allows the imaging device to produce multiple frames of image data with one sensor.

The memory resource 222 may store instructions 226, that when executed by the processing resource 221, cause the processing resource 221 to determine the motor speed to produce a set number of frames per revolution. In some examples, the speed of the motor determines the number of frames of image data produce in a revolution of the mirror and determine the number of frames of image data produced in a second. For instance, the motor can run at a speed from 14,400 revolutions per second (RPS) to produce thirty (30) frames of image data per second. In addition, the motor can run at a speed from about 43,200 RPS to produce ninety (90) frames of image data per second. In some examples, the motor can run at speeds from between 14,399 to 43,201 RPS depending on the setting of the motor and the quality of the sensor. However, this disclosure is not so limited. For example, depending on the type of motor and the capability of the motor, the speed of the motor can exceed 43,200 RPS. In some examples, the processing resource 221 determines the speed of the motor to determine the number of frames of image data the sensor will produce.

In some examples, the speed of the motor can be preset to produce a set number of frames of image data per second. The processing resource 221 receives the preset speed of the motor and determines the number of frames of image data that the sensor will produce. In some examples, the motor can be replaced with a higher quality motor that can reach speeds higher than 43,200 RPS to produce more frames of image data per second.

The memory resource 222 can store instructions 227, that when executed by the processing resource 221, cause the processing resource 221 to produce frames of images from the light reflected into the sensor. In some examples, the processing resource 221 causes the sensor to produce frames of image data when light is received from a mirror. When the imaging device is activated and the processing resource detects light being received through the plurality of lenses, the processing resource 221 activates the sensor. When the sensor begins to receive light from the mirror the processing resource 221 instructs the sensor to produce frames of image data using the light being received by the sensor.

The memory resource 222 can store instructions 228, that when executed by the processing resource 221, cause the processing resource 221 to determine if the frames of images in a revolution have a same image. In some examples, the sensor can produce frames of image data that are substantially the same as a previous frame of image data. In some examples, the processing resource can determine that the motor speed is too fast based on the sensor producing substantially the same frame of image data the same revolution. If the processing resource 221 determines that the motor speed is to fast the processing resource 221 will reduce the speed of the motor. In some examples, the processing resource can refrain from reducing the speed of the motor even if it is determined the sensor producing substantially the same frame of image data the same revolution. For instance, if a user determines that similar frames are acceptable, the processing resource 221 will refrain from reducing the speed of the motor.

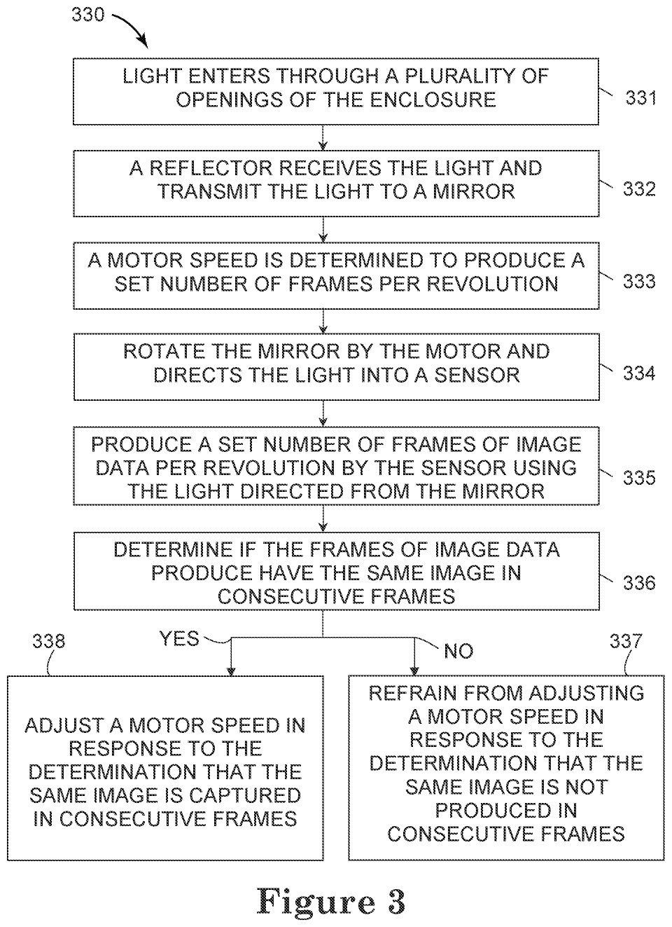

FIG. 3 illustrates an example of a flow diagram 330 suitable with an imaging device including a sensor consistent with the disclosure. The flow diagram 330 describes at 331 light entering through a plurality of openings of the enclosure. In some examples, the imaging device includes an enclosure having openings to receive light into the enclosure. The light received by the plurality of openings are used by a sensor to create frames of image data.

For example, the flow diagram 330 describes at 332 a reflector receiving the light and transmitting the light to a mirror. In some examples, the imaging device includes a plurality of reflector to receive light from a plurality of openings. For instance, the light received through the plurality of openings can pass through a lens prior to reaching the reflector. The reflector then transmits the light through a shaft to a mirror.

The flow diagram 330 describes at 333 a motor speed is determined to produce a set number of frames per revolution of a mirror. In some examples, a processing resource activates a motor to rotate a mirror as the mirror receives light from a reflector. The processing resource determines the speed of the motor to determine the number of frames of image data the imaging device will produce in a revolution of the mirror. The flow diagram 330 describes at 334 rotating the mirror by the motor and directing light into a sensor. In some examples, once the motor speed is determined, the motor will cause the mirror to rotate and receive light from a plurality of different angles. The mirror will reflect light from the plurality of angles into a sensor as the mirror rotates. The speed of the motor determines the speed of the rotating mirror. In addition, the speed of the rotating mirror dictates how fast the light is sent to the sensor from the mirror. In some examples, the quicker the sensor receives the light from the mirror the more frames of image data the imaging device can produce per revolution of the mirror.

The flow diagram 330 describes at 335 producing a set number of frames of image data per revolution using the light directed to the sensor from the mirror. In some examples, the sensor will produce a set number of frames of image data per revolution based on the determined motor speed and the speed of the mirror.

The flow diagram 330 describes at 336 determining if the frame of image data produce have the same image in consecutive frames. In some examples, if the frames of image data produced by the sensor has substantially the same image in consecutive frames of image data and/or substantially the same image in within the revolution, the processing resource can determine that the rotation speed of the mirror is too fast.

The flow diagram 330 describes at 338 adjusting a motor speed in response to the determination that the same image is captured in consecutive frames. If the processing resource determines that the frames of image data is substantially the same in consecutive frames and/or substantially the same in the same revolution, the processing resource can slow down the speed of the motor to reduce the speed in which the mirror rotates. This will reduce the number of frames of image data produced in a revolution by the sensor. That is, it will reduce the amount of light the mirror sends to the sensor in a revolution. In some examples, the processing resource can maintain the current motor speed based on directions provided by a user.

The flow diagram 330 describes at 337 refraining from adjusting a motor speed in response to the determination that the same image is not captured in consecutive frames. If the processing resource determines that the frames of image data is not substantially the same in consecutive frames and/or not substantially the same in the same revolution, the processing resource will refrain from adjusting the motor speed. In contrast, if the processing resource determines that there is not enough image data, the processing resource can cause the speed of the motor to increase.

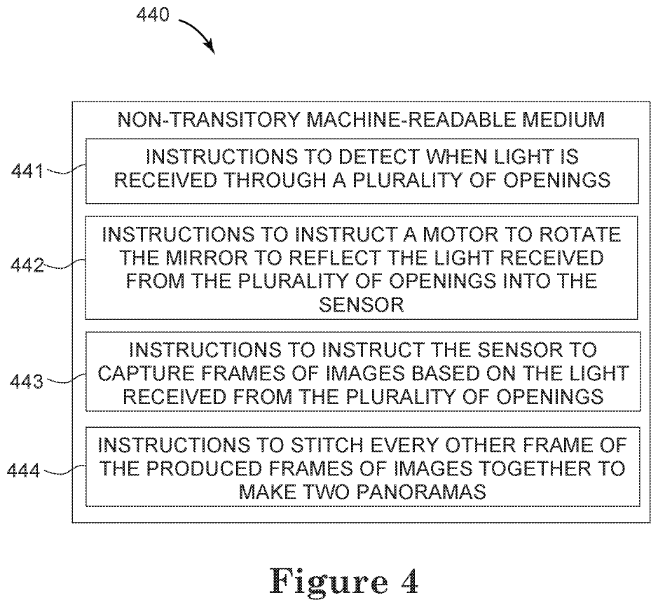

FIG. 4 illustrates an example diagram of a non-transitory machine-readable medium 440 suitable with an imaging device including a sensor consistent with the disclosure. The non-transitory machine-readable medium 440 may be any type of volatile or non-volatile non-transitory memory, such as random-access memory (RAM), flash memory, read-only memory (ROM), storage volumes, a hard disk, or a combination thereof.

The medium 440 stores instruction 441 executable by a processing resource to detect when light is received through a plurality of openings. In various examples, the processing resource can execute activate instructions 441 to activate an imaging device including a sensor. In some examples, the processing resource can activate the imaging device and detect when light is being received through the plurality of openings. In some examples, a lens covers each opening of the plurality of openings as light enters the opening. That is, the lens can rotate as a motor rotates a mirror and transmit light from a reflector, rotating with the mirror, through a shaft to the mirror. That is, as light enters the opening the lens can cover the opening to transmit the light from the opening to the reflector. Once the light is detected as being received by the plurality of openings the processing resource can begin to activate other elements within the imaging device. For example, the processing resource can activate a sensor of the imaging device to prepare the sensor before sensor receives the light from the plurality of openings.

In some examples, the light entering the enclosure through the lens is received by a reflector. The reflector is positioned within an enclosure connected to a shaft that connects the reflector to a rotating mirror. In some examples, using one lens to receive light from a plurality of openings reduces the cost of the imaging device. That is, the imaging device using one lens to obtain light from a plurality of openings will be produced at a lower cost compared to devices including imaging sensors that have multiple lenses. In addition, the size of the imaging device is reduced when less lenses are used to receive light.

However, this disclosure is not so limited. For example, the imaging device can include a lens positioned at each opening of the enclosure. The imaging device can include a plurality of reflectors to receive light from the plurality of lenses and transmit the light to the rotating mirror.

The medium 440 stores instruction 442 executable by a processing resource to instruct a motor to rotate the mirror to reflect the light received from the plurality of openings into the sensor. In some examples, the processing resource can execute activate instructions to activate a motor. The motor is activated when the processing resource detects that light has entered the plurality of openings. The motor causes a mirror to rotate as it receives light from a plurality of openings. In some examples, rotating the mirror as light is received from a plurality of openings and reflecting the light to the sensor allows an individual sensor to behave as multiple sensors. For example, because of the rotating mirror, the one sensor can receive light from multiple angles (i.e., the angles as determined by the position of the plurality of openings) of the imaging device allowing the one sensor to produce frames image data from different angles. That is, producing image data from multiple angles would usually be performed by a device with multiple sensors. Using one sensor to produce frames of image data from multiple angles, can reduce the cost and size of the imaging device. For instance, the imaging device can be made more compact than imaging devices that use multiple sensors. Similarly, using less product to produce the imaging device (i.e., one sensor and/or one lens) can reduce the cost of the imaging device, as compared to imaging devices that use multiple sensors and/or multiple lenses.

The medium 440 stores instruction 443 executable by a processing resource to instruct the sensor to capture frames of images based on the light received from the plurality of openings. In various examples, the processing resource can execute initiate instructions 443 to cause the sensor to produce frames of image data based on the light received from the rotating mirror. In some examples, the frames of image data produced by the sensor is synchronized with the speed of the motor. That is, the motor speed determines the number of frames the sensor will produce in one revolution of the mirror or within one second.

The medium 440 stores instruction 444 executable by a processing resource to stitch every other frame of the produced frames of images together to make two panoramas. In various examples, the processing resource can execute create instructions 444 to produce two panoramas from the frames of image data to create a 3-dimensional (3D) image. For example, if the sensor produces sixteen (16) frames of image data in 2 revolutions, then frames 1, 3, 5, 7, 9, 11, 13, and 15 will be stitched together to make the first panorama and frames 2, 4, 6, 8, 10, 12, 14, and 16 will be stitched together to make the second panorama. The number of frames of image data being stitched together can vary depending on the number of frames of image data produced by the sensor. In some examples, after the processing resource creates the two panoramas, the two panoramas can then be sent to an external computing device. the external computing device can then create the 3D image from the two panoramas.

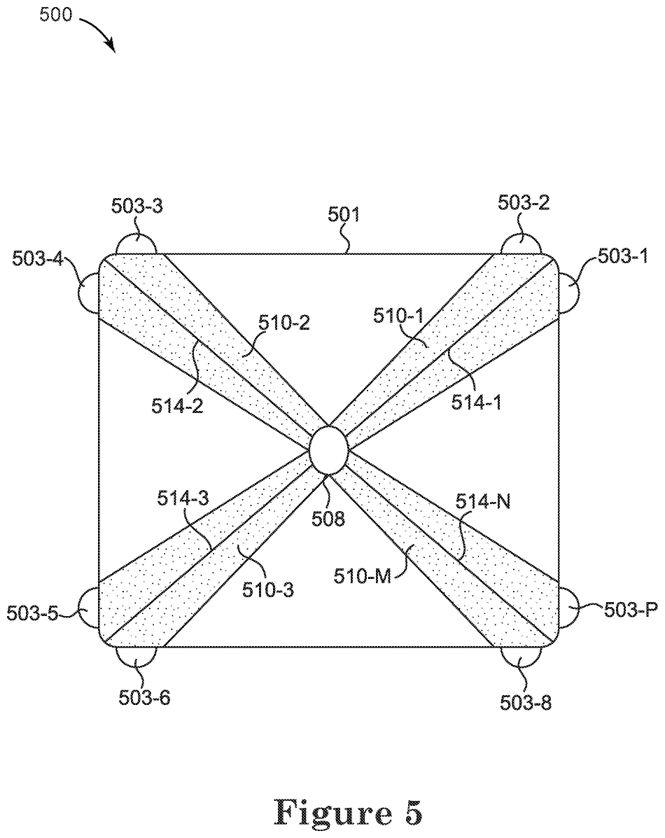

FIG. 5 illustrates an example of an imaging device 500 including a sensor consistent with the disclosure. FIG. 5 can include analogous or similar elements as FIG. 1. For example, FIG. 5 includes an imaging device 500, an enclosure 501, a motor 508, a plurality of reflectors 510, and a plurality of shafts 114.

In some examples, the imaging device 500 includes an enclosure 501 including a plurality of openings 503. The plurality of openings can include a plurality of lenses. For example, a lens from the plurality of lenses can cover an opening 503 of the plurality of openings 503. However, this disclosure is not so limited. For example, the enclosure can include one lens to cover an opening 503 of the plurality of openings 503 as light is received by the opening. In some examples, the light is transmitted from the plurality of openings to a plurality of reflector 510. The reflector 510 send the light to a mirror, positioned substantially in the center of the enclosure 501, via a shaft 514. In some examples, the motor 508 causes the mirror to rotate when light is detected at an opening 503. The motor 508 is parallel to a first side of the mirror. That is, the motor 508 is positioned substantially in the center of the imaging device 500.

In some examples, the mirror transmits light to a sensor as the mirror rotates. In some examples, the sensor is parallel to a second side of the mirror, where the first side of the mirror is opposite the second side of the mirror. For instance, the sensor is positioned substantially in the center of the imaging device 500 on the second side of the mirror.

The figures herein follow a numbering convention in which the first digit corresponds to the drawing figure number and the remaining digits identify an element or component in the drawing. Similar elements or components between different figures can be identified by the use of similar digits. For example, 102 can reference element “02” in FIG. 1, and a similar element can be referenced as 502 in FIG. 5.

Elements shown in the various figures herein can be capable of being added, exchanged, and/or eliminated so as to provide a number of additional examples of the disclosure. In addition, the proportion and the relative scale of the elements provided in the figures are intended to illustrate the examples of the disclosure and should not be taken in a limiting sense.

The above specification and examples provide a description of the method and applications and use of the system and method of the present disclosure. Since many examples can be made without departing from the scope of the system and method, this specification merely sets forth some of the many possible example configurations and implementations.

It should be understood that the descriptions of various examples may not be drawn to scale and thus, the descriptions can have a different size and/or configuration other than as shown therein.

1. An imaging device, comprising:
a plurality of lenses to receive light;
a reflector to transmit the light from the plurality of lenses through a shaft;
a single image sensor for producing a set of frames of image data based on received light;
a mirror to receive the light transmitted by the reflector and reflect the light into the single image sensor;
a motor to rotate the mirror to allow the mirror to channel light into the sensor, wherein the single image sensor produces the set of frames of image data based on the light received from the mirror; and
a processing resource to synchronize a motor speed based on the set of frames.

2. The imaging device of claim 1, wherein the processing resource is to send the set of frames to an external computing device.

3. The imaging device of claim 1, wherein a quantity of the frames produced in a revolution of the mirror is based on a speed of the motor.

4. A non-transitory memory resource storing machine-readable instructions stored thereon that, when executed, cause a processing resource of a computing device to:
detect when light is received through a plurality of lenses positioned on a surface of an enclosure;
detect when a reflector transmits the light through a shaft to contact a mirror;
instruct a motor to rotate the mirror to reflect the light from the plurality of lenses into a single sensor;
determine a speed of the motor to produce a set of frames of image data per revolution;
produce the set of frames based on the light reflected into the single sensor; and
determine when the set of frames in a revolution match.

5. The memory resource of claim 4, wherein the instructions are executed further to cause the processing resource to adjust the motor speed, in response to the determination that the frames in a revolution match.

6. The memory resource of claim 4, wherein every other frame of the produced frames of images are stitched together to make two panorama images.

7. The memory resource of claim 6, wherein the two panorama images are used to create a three-dimensional (3D) image.

8. The memory resource of claim 4, wherein the frames of image data produced in a revolution produces image data from a plurality of different angles.

9. An imaging device, comprising:
an enclosure that includes:
a plurality of openings positioned on a surface of the enclosure to receive light;
a shaft to connect a reflector to a mirror
the reflector to receive the light from each opening of the plurality of openings and transmit the light through the shaft to the mirror;
a single image sensor for producing a set of frames of image data based on received light; and
the mirror to reflect the light into the single image sensor; and a processing resource to:
instruct a motor to rotate the mirror to reflect the light received from the plurality of openings into the single image sensor; and
instruct the single image sensor to capture frames of images based on the light received from the plurality of openings.

10. The imaging device of claim 9, further comprising a plurality of lenses, wherein each unique lens of the plurality of lenses is paired to a unique opening of the plurality of openings to cover the plurality of openings.

11. The imaging device of claim 9, further comprising a single lens to cover each unique opening of the plurality of openings.

12. The imaging device of claim 11, wherein the single lens rotates as the mirror rotates to cover each unique opening of the plurality of openings as light is received by each unique opening.

13. The imaging device of claim 9, wherein the mirror is located substantially in a center of the enclosure.

14. The imaging device of claim 9, wherein the processing resource is to:
determine when a same image is produced in consecutive frames captured by the sensor; and
adjusting a motor speed in response to the determination that the same image is captured in consecutive frames.

15. The imaging device of claim 9, wherein the processing resource is to:
determine when a same image is produced in consecutive frames captured by the sensor; and
refrain from adjusting a motor speed in response to the determination that the same image is not captured in consecutive frames.
